(19) United States
(12) Patent Application Publication
(10) Pub. No.: US 2016/0071124 A1
(43) Pub. Date: Mar. 10, 2016

(54) SYSTEM AND METHOD FOR PREDICTIVE ACCOUNT TARGETING

(71) Applicant: FLIPTOP INC., San Francisco, CA (US)

(72) Inventors: Claire Lavergne, San Francisco, CA (US); Dan Chiao, South San Francisco, CA (US); Doug Camplejohn, San Francisco, CA (US)

(21) Appl. No.: 14/659,581

(22) Filed: Mar. 16, 2015

Related U.S. Application Data
(60) Provisional application No. 62/048,134, filed on Sep. 9, 2014.

(51) Int. Cl. G06Q 30/02

(52) U.S. Cl. CPC G06Q 30/0202

(57) ABSTRACT

A system and method for predictive account targeting are disclosed. A particular embodiment includes providing, by a data processor, data communication with a database including a plurality of accounts, each account having a plurality of associated account attributes; generating, by the data processor, a user interface for a user at a user platform; presenting to the user, by use of the user interface, a plurality of account attribute options associated with the plurality of accounts; enabling the user to create an account list associated with a targeted portion of the plurality of accounts having account attributes corresponding to a selected account attribute option; and enabling the user to attribute or assign the account list of targeted accounts to a particular individual, entity, or activity.

### PRIORITY PATENT APPLICATION

This is a non-provisional patent application drawing priority from co-pending U.S. provisional patent application Ser. No. 62/048,134; filed Sep. 9, 2014. This present non-provisional patent application draws priority from the referenced provisional patent application. The entire disclosure of the referenced patent application is considered part of the disclosure of the present application and is hereby incorporated by reference herein in its entirety.

### TECHNICAL FIELD

This patent application relates to computer-implemented software and networked systems, according to one embodiment, and more specifically, to a system and method for predictive account targeting.

### BACKGROUND

Lead scoring is a well-known technique for determining the quality of sales leads received or generated by a business. Many companies use a manual, hand-tuned lead scoring system, which is time consuming to construct and error-prone. Such methods are generally used by the marketing team of a business to determine marketing qualified leads (MQLs). Marketing automation software facilitates the creation of such lead scoring systems. Although the potential benefit of marketing automation has been recognized since at least 1989, according to some sources, only 40% of sales teams with marketing automation think that their marketing automation adds value. Therefore, such systems still result in low quality MQLs being handed off to sales teams, making the sales qualification process expensive, less efficient, and time consuming.

### BRIEF DESCRIPTION OF THE DRAWINGS

The various embodiments are illustrated by way of example, and not by way of limitation, in the figures of the accompanying drawings in which:

FIG. 1 illustrates an example embodiment of a system and method for predictive account targeting;

FIG. 2 illustrates an example embodiment of an account and its associated attributes;

FIGS. 3 through 9 illustrate sample pages or views of a user interface presented to a user by the predictive account management system of an example embodiment when the predictive account targeting module of the example embodiment is activated;

FIG. 10 is a processing flow chart illustrating an example embodiment of a method as described herein; and

FIG. 11 shows a diagrammatic representation of a machine in the example form of a stationary or mobile computing and/or communication system within which a set of instructions when executed and/or processing logic when activated may cause the machine to perform any one or more of the methodologies described and/or claimed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for predictive account targeting are described. As disclosed herein, an account is an entity (e.g., an individual, a company, a business, an organization, a foundation, a government agency, etc.) that is either a prospective customer or a current customer (e.g., likely to buy or lease products or engage for services) of a host. A lead is a contact point associated with the account entity (e.g., an individual at a company, etc.) that may become a prospective customer or influence the associated account entity to become a customer. Each account may have zero, one or more leads associated with the account. A key purpose of the predictive account targeting system as disclosed in various example embodiments herein is to identify accounts that have a high likelihood to become customers and then segment the identified accounts using selectors. In this manner, the example embodiments can generate a predictive account targeting list. In order to actually sell products or services to those identified accounts, the marketing and sales team of the host must then generate leads from those accounts on the predictive account targeting list. The process of generating leads from a predictive account targeting list can involve activities or operations including: 1) scraping or querying publicly-available online sources for individuals (contact points) working at or connected with the accounts on the predictive account targeting list, 2) working with lead generation vendors to purchase lists of individuals (contact points) working at or connected with the accounts on the predictive account targeting list, and/or 3) working with online advertising vendors to show advertising to individuals (contact points) working at or connected with the accounts on the predictive account targeting list. These features of the various embodiments are described in more detail below.

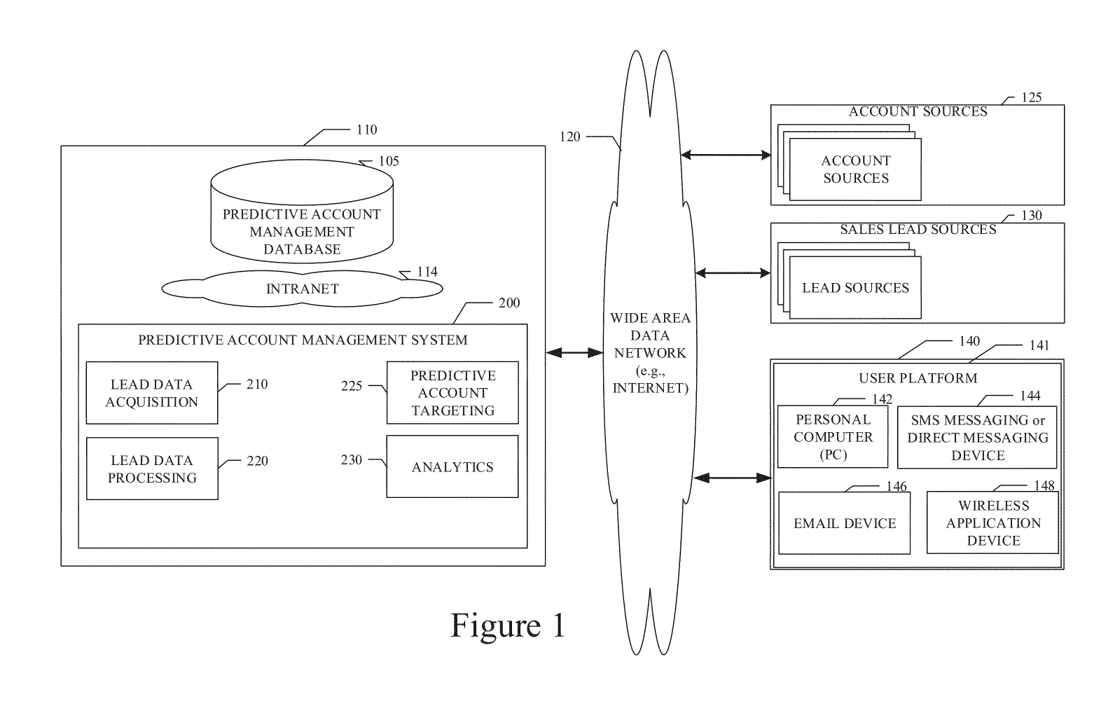

Referring to FIG. 1, in an example embodiment, a system and method for predictive account targeting are disclosed. In various example embodiments, an application or service, typically operating on a host site (e.g., a website) 110, is provided to simplify and facilitate predictive account management for a user at a user platform 140 from the host site 110. The host site 110 can thereby be considered a predictive account management site 110 as described herein. In the various example embodiments, the application or service provided by or operating on the host site 110 can facilitate the downloading or hosted use of the predictive account management system 200 of an example embodiment. In a particular embodiment, the predictive account management system 200, or a portion thereof, can be downloaded from the host site 110 by a user at a user platform 140. Alternatively, the predictive account management system 200 can be hosted by the host site 110 for a networked user at a user platform 140. Multiple account sources 125 represent any of a plurality of account sources, which may include the network addresses of an entity (e.g., an individual, a company, a business, an organization, a foundation, a government agency, etc.) that is either a prospective customer or a current customer (e.g., likely to buy or lease products or engage for services) of a host. It will be apparent to those of ordinary skill in the art that account sources 125 can be any of a variety of offline or online (networked) account sources. Multiple lead sources 130 can provide a plurality of sales leads, which may produce conversion to a sales opportunity. In an example embodiment, the plurality of sales leads can be contact points in any of the account sources 125. It will be apparent to those of ordinary skill in the art that lead sources 130 can be any of a variety of offline or online (networked) sales lead sources, email marketing services, social network sources, or sales lead aggregators as described in more detail below. For example, lead sources 130 can include social media channels, such as Facebook, Twitter, or YouTube, email marketing sites, such as MailChimp, Constant Contact, or ExactTarget, industry events, organic traffic from search engines, traffic from online advertising, and the like. The predictive account management site 110, account sources 125, lead sources 130, and user platforms 140 may communicate and transfer account information, lead information, and other information via a wide area data network (e.g., the Internet) 120. Various components of the predictive account management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The account sources 125 and lead sources 130 may include any of a variety of providers of network transportable digital content. Typically, the file format that is employed is XML, however, the various embodiments are not so limited, and other file or data formats may be used. For example, data feed formats other than HTML/XML or formats other than open/standard feed formats can be supported by various embodiments. Any electronic file format, such as Portable Document Format (PDF), text, audio (e.g., Motion Picture Experts Group Audio Layer 3-MP3, and the like), video (e.g., MP4, and the like), and any proprietary interchange format defined by specific content sites can be supported by the various embodiments described herein.

In a particular embodiment, a user platform 140 with one or more client devices 141 enables a user to access information from the account sources 125 and lead sources 130 via the network 120. Client devices 141 may include virtually any computing device that is configured to send and receive information over a network, such as network 120. Such client devices 141 may include portable devices 144 or 146 such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 141 may also include at least one client application (app) that is configured to receive data or messages from another computing device via a network transmission. The client application may include a capability to provide and receive textual content, graphical content, video content, audio content, alerts, messages, notifications, and the like. Moreover, client devices 141 may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 141 may also include a wireless application device 148 on which a client application is configured to enable a user of the device to receive account information from at least one account source 125 and leads from at least one lead source 130. As such, the user at user platform 140 can receive account information and leads through the client device 141. Moreover, the account information and lead data may be provided to client devices 141 using any of a variety of delivery mechanisms, including IM, SMS, Twitter, Facebook, MMS, IRC, EMS, audio messages, HTML, email, or another messaging application. In a particular embodiment, the client application executable code used for predictive account management as described herein can itself be downloaded to the wireless application device 148 via network 120.

Referring still to FIG. 1, host site 110 of an example embodiment is shown to include a predictive account management system 200, intranet 114, and predictive account management database 105. Predictive account management system 200 includes lead data acquisition module 210, lead data processing module 220, predictive account targeting module 225, and analytics module 230. Each of these modules can be implemented as software components executing within an executable environment of predictive account management system 200 operating on host site 110 or on a user platform 140 device. Each of these modules of an example embodiment is described in more detail below in connection with the figures provided herein.

Referring still to FIG. 1, lead data acquisition module 210 can be in data communication with the plurality of account sources 125, the plurality of lead sources 130, one or more portions of data storage device 105, and the other processing modules 220, 225, and 230 of the predictive account management system 200. In general, the lead data acquisition module 210 is responsible for enabling a user system to receive account information of interest from the account sources 125 or sales lead data of interest from any of the variety of lead sources 130. The lead data acquisition module 210 can also be considered a web front end module that can interact with users via a graphical user interface and with account sources or lead sources via application programming interfaces (API's) as described in more detail below.

In a particular embodiment, lead data acquisition module 210 can be configured to interface with any of the account sources 125 or the lead sources 130 via wide area data network 120. Because of the variety of account sources 125 and lead sources 130 providing account information and sales leads to lead data acquisition module 210, the lead data acquisition module 210 may need to manage each account source 125 and lead source 130. This source management process includes retaining information about each account source 125 and each lead source 130, including an identifier or address of the corresponding account source 125 and lead source 130, the timing associated with the account source 125 and lead source 130, including the time when the latest content update was received and the time when the next update is expected, and the like. This source information can be stored in database 105.

Referring still to FIG. 1, the lead data processing module 220 is responsible for automatically processing the account and lead data received by the lead data acquisition module 210 in ways to make the account and lead data useful and informative for the user. The lead data processing module 220 can use a batch controller to collect or aggregate the account and lead data in off-line processes. The lead data processing module 220 can also be considered a back end module that can interact with account sources or lead sources in an off-line mode via application programming interfaces (API's) as described in more detail below. The processed account and sales lead information can be stored in database 105.

Referring still to FIG. 1, the analytics module 230 can be used by the lead data processing module 220 to generate, among other information and metrics, ranking data related to accounts and sales leads. In the example embodiment disclosed herein, a process is described for predictive account targeting based on a database of account information and sales leads. The database of account information and sales leads can be generated using a sales lead generation and prioritization system, such as the sales lead prioritization system disclosed in the priority patent application referenced above. The lead data processing module 220 and/or the analytics module 230 can be used to implement an account and sales lead prioritization system in an example embodiment. The lead data processing module 220 and/or the analytics module 230 can also be used to generate a database of processed, ranked, and prioritized accounts and sales leads, which can be stored in database 105. In a particular embodiment, the lead data processing module 220 and/or the analytics module 230 can use machine learning and/or statistical processes to do the ranking and prioritization of the accounts and sales leads.

Referring still to FIG. 1, predictive account targeting module 225 is responsible for automatically processing the account information and the lead data received by the lead data acquisition module 210 and processed by the lead data processing module 220 and/or the analytics module 230 in ways to make the account information and lead data useful and informative for predictive account targeting. One way the account information and the lead data can be made more useful and informative is to isolate the various attributes of each account and segment the accounts into groupings with associated selectors as described in more detail below. Then, the account attributes can be used to categorize, filter, and aggregate the accounts retained in the database 105. The lead data processing module 220, the predictive account targeting module 225, and the analytics module 230 can be used to implement this process in an example embodiment. This process in an example embodiment is described in more detail below.

### Predictive Account Targeting

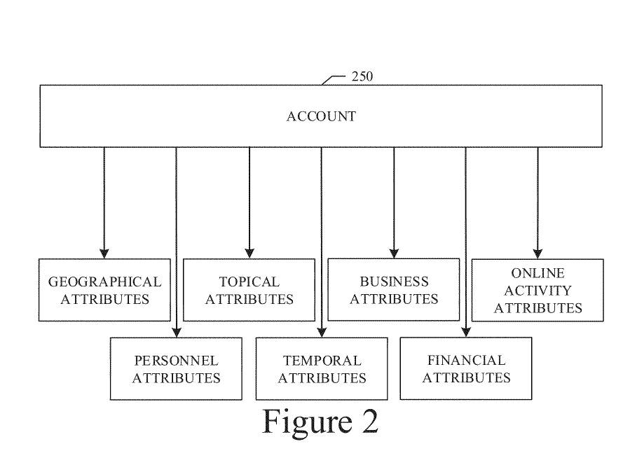

FIG. 2 illustrates an example embodiment of an account 250 and its associated attributes. In an example embodiment, each account 250 can have a plurality of associated attributes, such as geographical attributes, topical attributes, business attributes, personnel attributes, temporal attributes, financial attributes, online activity attributes, and/or a variety of other associated characteristics. It will be apparent to those of ordinary skill in the art in view of the disclosure herein that a variety of other associated attributes or characteristics can be associated an account. The geographical attributes associated with an account 250 can correspond to the geographical locations, regions, or boundaries from which prospective sales associated with the account may originate. The geographical attributes associated with an account 250 can also correspond to a geographical location from which the account was sourced. The topical attributes associated with an account 250 can correspond to the types of products, services, markets, or technologies that relate to the account. The topical attributes can be used to associate an account with one or more vertical markets in a commercial ecosystem. The business attributes associated with an account 250 can correspond to the particular business characteristics that relate to the account. For example, the account may relate to companies of a particular size, companies with a particular market share, companies of a particular type (e.g., retailers, manufacturers, distributers, consumer-facing, enterprise-focused, etc.), companies with a particular number of employees, companies with a particular number of office locations, and/or the like. The personnel attributes associated with an account 250 can correspond to the individuals who sourced or facilitated the connection with the account, the individuals who are most suited to follow up on the account, the individuals who should be isolated from involvement with the account, etc. The temporal attributes associated with an account 250 can correspond to the time when the account was identified or received, a time when the account will become stale, a time before or after when action should be taken on the account, etc. The financial attributes associated with an account 250 can correspond to the potential value of sales the account may produce, the costs that may be incurred by following up on the leads associated with the account, and the like. The online activity attributes associated with an account 250 can correspond to the degree to which an account, or representatives thereof, engage in online activities, such as viewing, interacting with, forwarding, linking to, referring, or otherwise connecting with a portion of marketing content, the degree to which an account, or representatives thereof, engage in online activities, such as viewing, interacting with, forwarding, linking to, referring, or otherwise connecting with a portion of marketing content associated with a particular topic or set of topics, attend a virtual event, visit a particular website or webpage, click on particular links, and the like. It will be apparent to those of ordinary skill in the art in view of the disclosure herein that a variety of other associated attributes or characteristics can be associated with an account and that the account attribute data can be used in a variety of ways as disclosed or suggested herein.

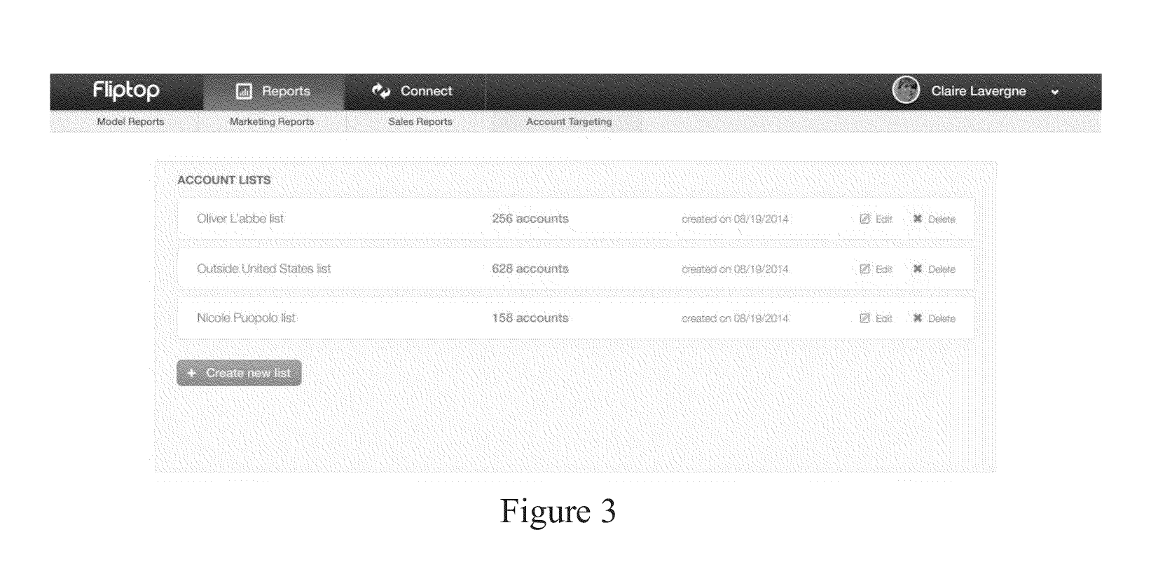

FIGS. 3 through 9 illustrate sample pages of a user interface presented to a user by the predictive account management system 200 of an example embodiment when the predictive account targeting module 225 of an example embodiment is activated or executed. As described above, a database 105 can be provided, in which a plurality of processed and ranked accounts 250 can be stored. Each account 250 can have a plurality of associated account attributes as described above. A data processor in the host 110 or at the user platform 140 can establish data communications with the database 105 and the plurality of accounts stored therein. Additionally, the data processor in the host 110 or at the user platform 140 can generate a user interface for a user at a user platform 140. Example embodiments of such a user interface are shown in FIGS. 3 through 9.

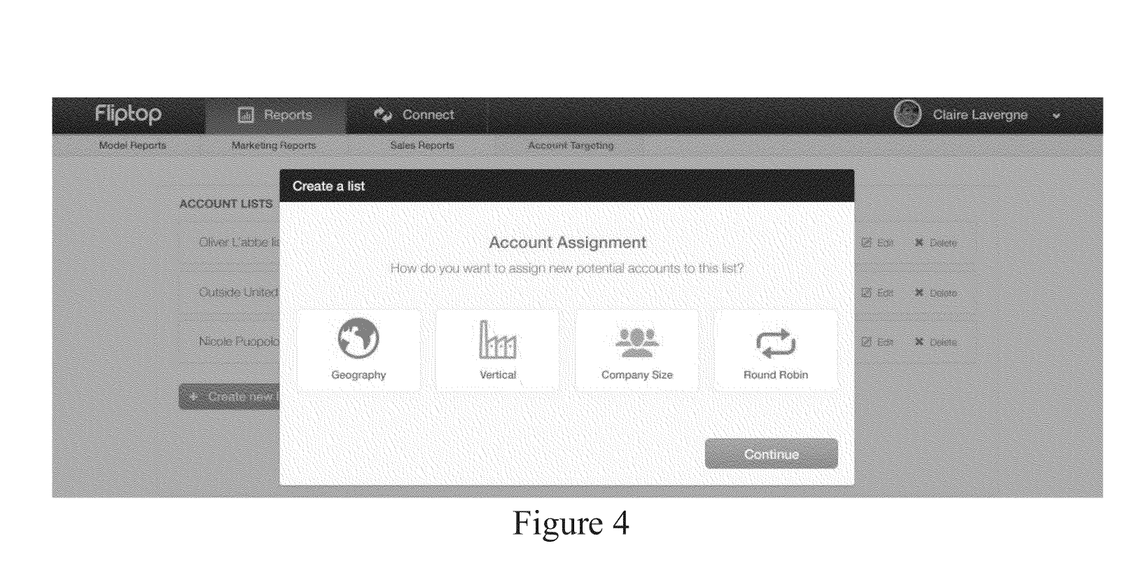

Referring now to FIG. 3, a first view of an example user interface presented to a user is shown. In the user interface view shown in FIG. 3, the user is presented with a list of previously-created targeted sales lead account lists. Each targeted account list shown corresponds to a targeted account list created in the manner described in more detail below. The example user interface view shown in FIG. 3 also includes a selector, button, icon, or input object (e.g. “Create new list”) with which the user can select an option to create a new targeted sales lead account list. Upon activation of this input object, the next view in the example user interface as shown in FIG. 4 is presented to the user.

Referring now to FIG. 4, a view of the example user interface presented to a user is shown after user activation of the “Create new list” input object as described above. The functionality for creating a new account list in an example embodiment enables the user to create a new account list. In the user interface view shown in FIG. 4, the user is presented with a plurality of account attribute options associated with the plurality of accounts stored in database 105. In an example embodiment, each account attribute option can correspond to a particular attribute of the plurality of accounts. In other embodiments, the account attribute options presented to the user can correspond to combinations of attributes of the plurality of accounts. As described above, each account stored in database 105 can have a plurality of associated attributes, such as geographical attributes, topical attributes, business attributes, personnel attributes, temporal attributes, financial attributes, online activity attributes, and/or a variety of other associated characteristics. The account attribute options presented to the user can be configured to correspond to one or more of these account attributes. For example, as shown in FIG. 4, the user is presented with four account attribute options: geography, vertical, company size, and round robin. These account attribute options can be used by the user to select the type of accounts the user wants to associate with the new account list being created. In this manner, the user can target the desired set of accounts for the new account list. In the example embodiment shown in FIG. 4, the user may select the account attribute option: “geography”. As a result, the predictive account targeting module 225 of the example embodiment is configured to focus on the geographical attributes of the accounts stored in database 105. Similarly, the user may select the account attribute option: “vertical”. When this selection is made, the predictive account targeting module 225 is configured to focus on the topical attributes of the accounts stored in database 105. The user may also select the account attribute option: “company size”. When this selection is made, the predictive account targeting module 225 is configured to focus on the business attributes of the accounts stored in database 105. Finally, in the example shown in FIG. 4, the user may select the option: “round robin”. When this selection is made, the predictive account targeting module 225 can be configured to randomly select various attributes of the accounts stored in database 105 in a round robin fashion. It will be apparent to those of ordinary skill in the art in view of the disclosure herein that a variety of other account attribute options associated with various account attributes or characteristics can be similarly presented to a user via the user interface provided by the predictive account targeting module 225 of an example embodiment. Thus, as described in more detail below, the user is enabled to create an account list associated with a targeted portion of the plurality of accounts stored in database 105 having account attributes corresponding to a selected account attribute option.

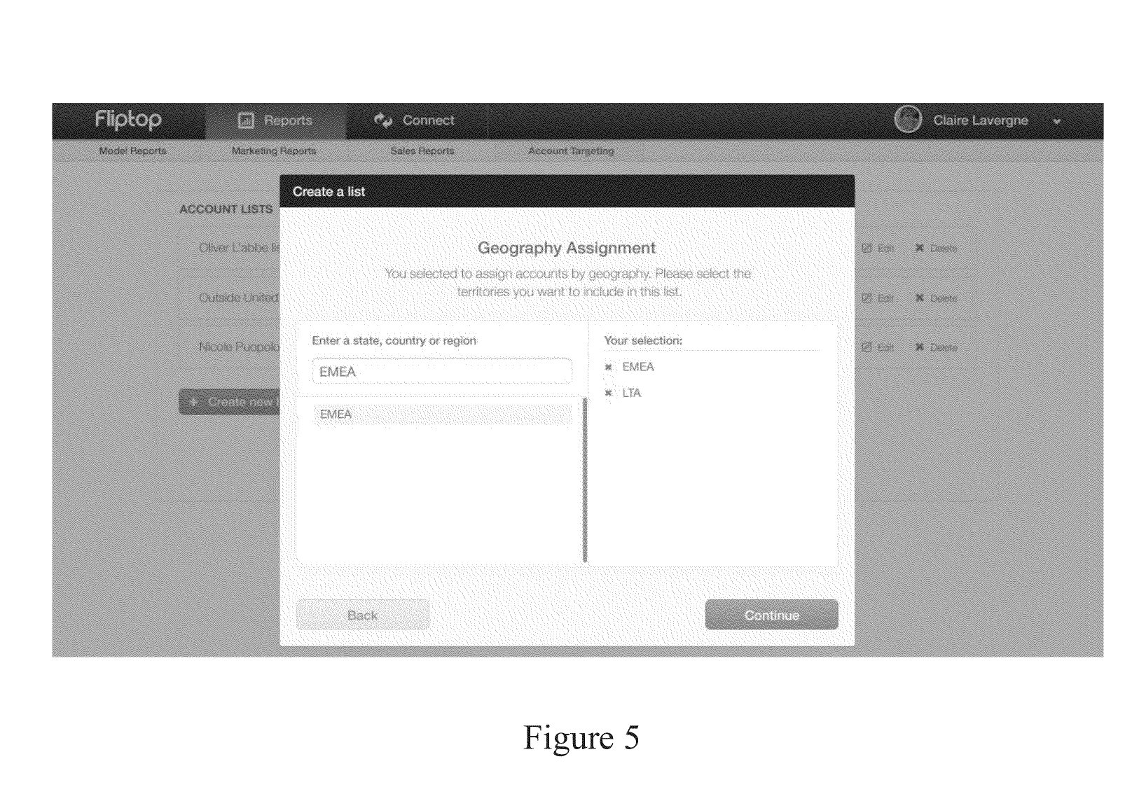

Referring now to FIG. 5, a view of the example user interface presented to a user is shown after user activation of the input object corresponding to the account attribute option: “geography” as described above. It will be apparent to those of ordinary skill in the art in view of the disclosure herein that any of the other account attribute options can be similarly selected by the user via the user interface shown in FIG. 4 or via an alternative user interface in another embodiment. In the example shown in FIG. 5, the user has opted to create an account list targeted for accounts corresponding to desired geographical attributes. As a part of this focus on the geographical attributes of the accounts, the user can be prompted by the user interface view shown in FIG. 5 to specify the details of the particular desired geographical attributes. In the example embodiment, the user can be prompted to enter desired geographical locations, territories, regions, boundaries, or other geographical attributes that can be used to search and retrieve matching accounts from the database 105. Input objects can also be provided in the user interface shown in FIG. 5 to enable the user to include or omit one or more geographical locations from the set of desired geographical locations specified in the user interface shown in FIG. 5. As a result, the user can target specific accounts from the database 105 that correspond to desired geographical attributes for inclusion in the set of accounts associated with the newly created account list. In a similar manner, the user can be prompted by other similar user interface views to specify the details of the other particular desired account attributes. Thus, the predictive account targeting module 225 enables the user to create a new account list with a targeted set of accounts from database 105, wherein each of the included accounts has account attributes corresponding to a desired set of attributes.

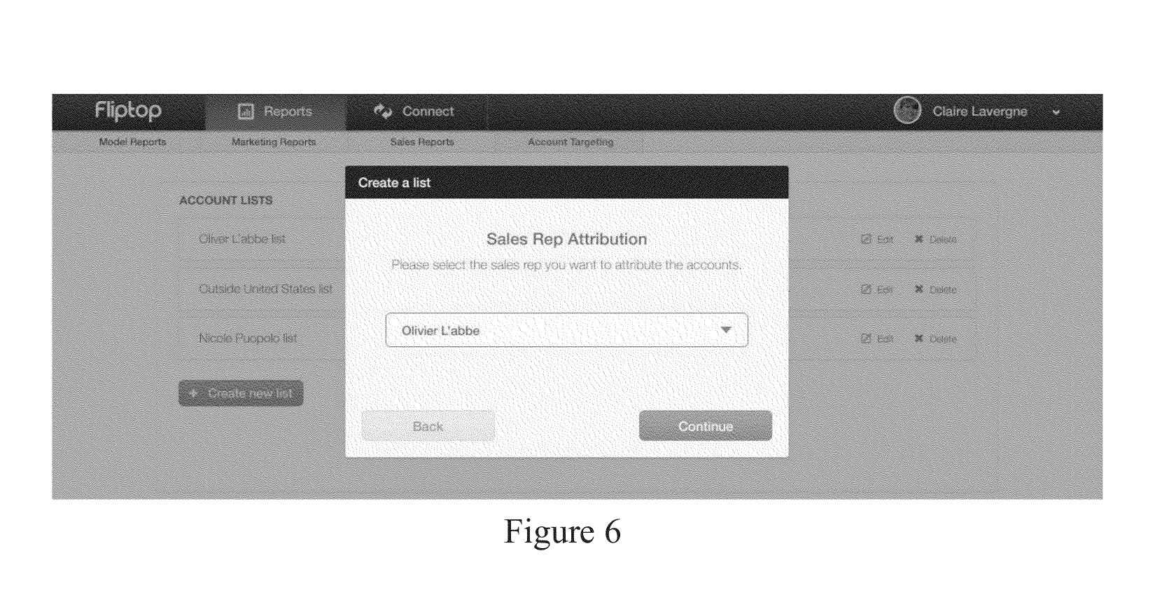

Referring now to FIG. 6, a view of the example user interface presented to a user is shown after the user has completed the specification of the details of the particular desired account attributes as described above. In the example shown in FIG. 6, the user can be prompted to enter the name of an individual or pre-existing entity (e.g., a sales representative) to whom attribution can be given for the targeted accounts in the newly created account list. In this manner, the newly created account list can be attributed to a particular individual, set of individuals, group, project, campaign, organization, or other defined entity or activity. In a similar manner, the user can be prompted to enter the name of an individual or pre-existing entity (e.g., a sales representative) to whom the newly created account list can be assigned. Thus, the predictive account targeting module 225 enables the user to attribute or assign the list of targeted accounts to a particular individual, entity, or activity.

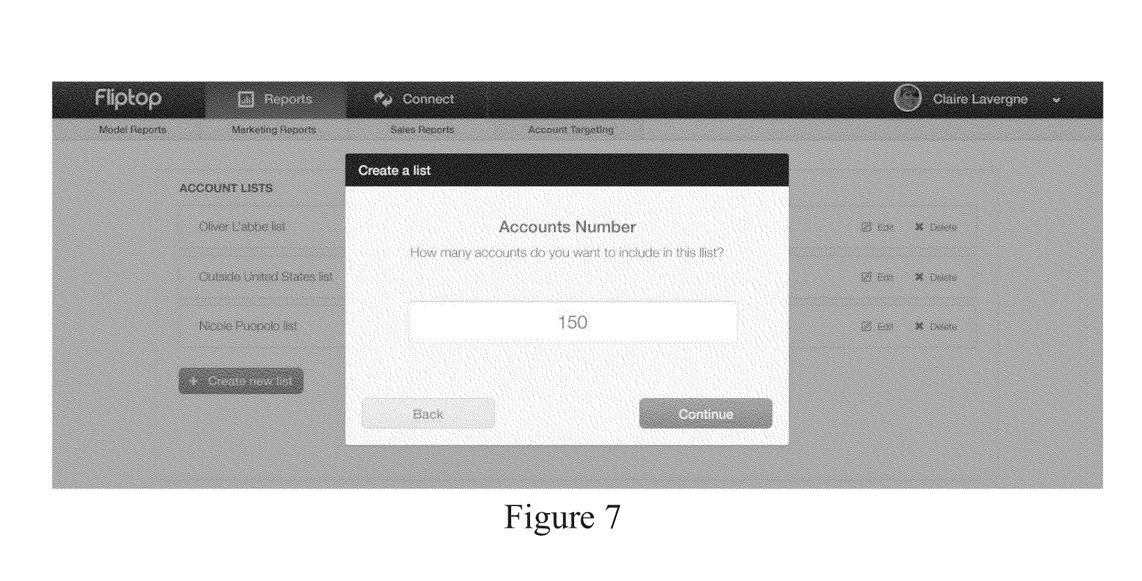

Referring now to FIG. 7, a view of the example user interface presented to a user is shown after the user has completed the specification of the attribution or assignment of the targeted account list as described above. In the example shown in FIG. 7, the user can be prompted to enter a numeric quantity or formula corresponding to the number of targeted accounts that should be included in the newly created account list. In a particular embodiment, the entered quantity can serve as a maximum value; the newly created account list can include a number of accounts equal to or less than the specified quantity. In a particular embodiment, the ranking or prioritization data related to the accounts as described above can be used to sort the account list. Then, the highest ranking accounts matching the desired account attributes can be included in the newly created account list until the entered quantity of targeted accounts is reached. In this manner, the specified number of highest ranking targeted accounts can be included in the newly created account list.

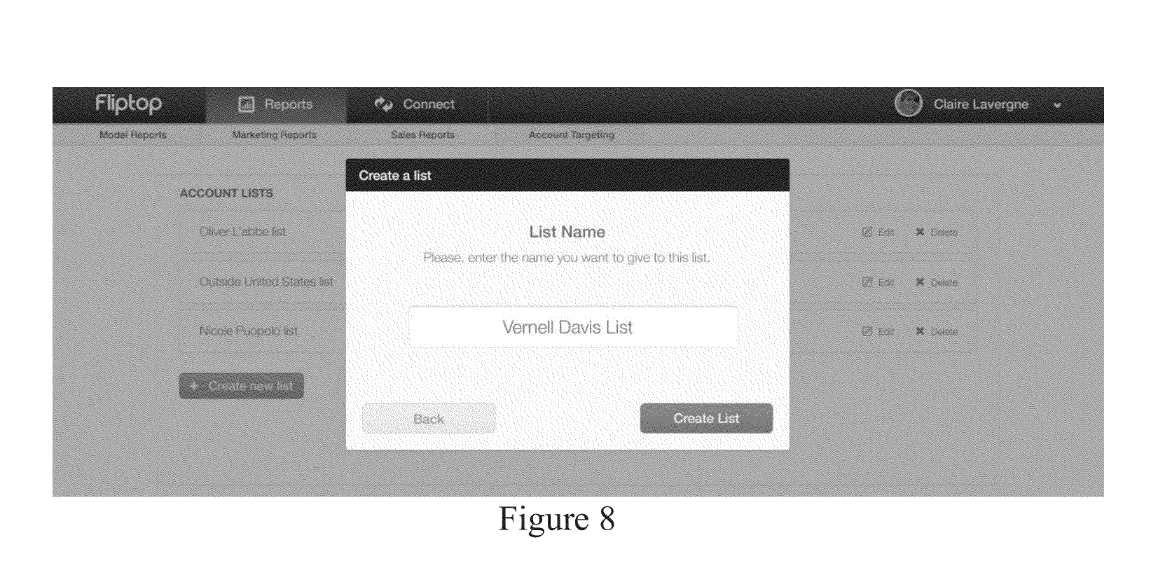

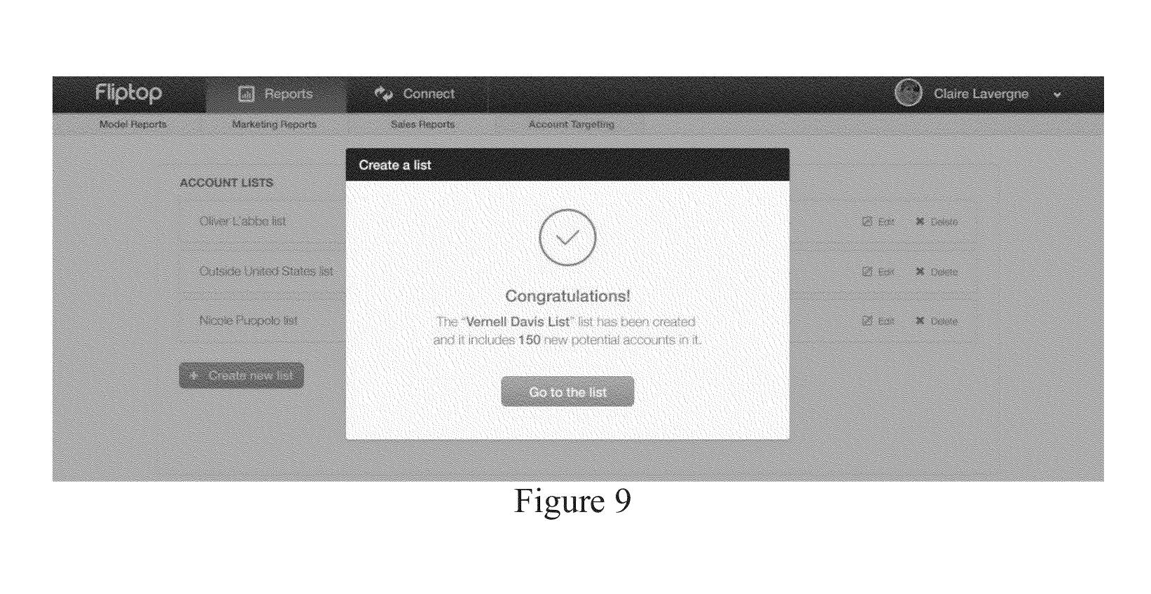

Referring now to FIG. 8, a view of the example user interface presented to a user is shown after the user has specified the desired quantity of targeted accounts to include in the newly created account list as described above. In the example shown in FIG. 8, the user can be prompted to enter a name of the newly created account list. The specified name is applied to the new account list. Upon user activation of a provided input object (e.g., “Create List”), the targeted sales lead account list is created with the compilation of targeted accounts having the user-specified account attributes, the user-specified attribution, the user-specified quantity of targeted accounts, and the user-specified account list name. As shown in FIG. 9, a confirmation of the created account list can be presented to the user as part of a view of the example user interface presented to the user. In this manner, a system and method is provided for predictive account targeting based on a database of account information and sales leads.

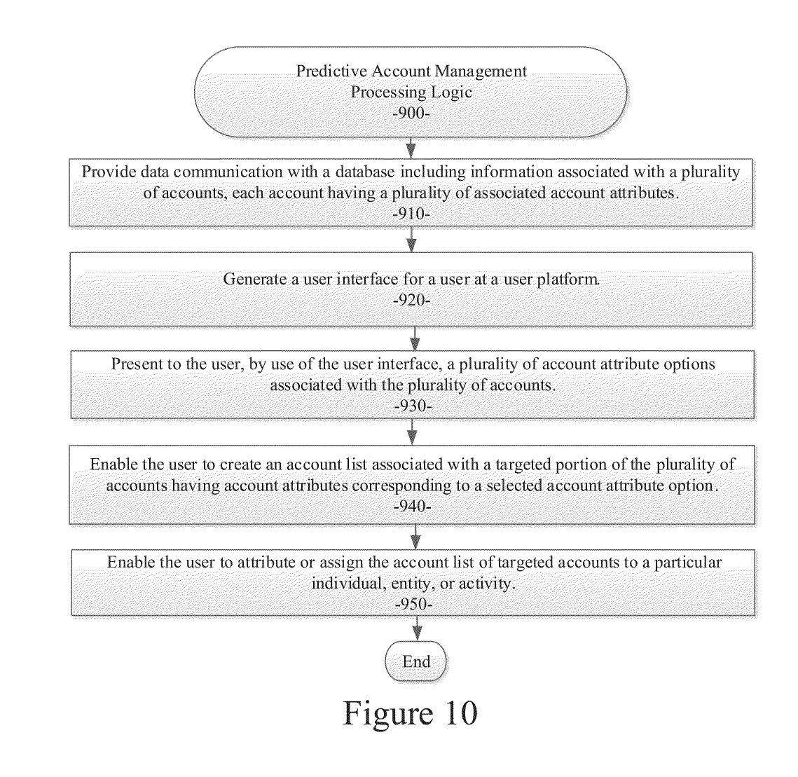

Referring now to FIG. 10, a processing flow diagram illustrates an example embodiment of a predictive account management system 200 as described herein. The method 900 of an example embodiment includes: providing, by a data processor, data communication with a database including information associated with a plurality of accounts, each account having a plurality of associated account attributes (processing block 910); generating, by the data processor, a user interface for a user at a user platform (processing block 920); presenting to the user, by use of the user interface, a plurality of account attribute options associated with the plurality of accounts (processing block 930); enabling the user to create an account list associated with a targeted portion of the plurality of accounts having account attributes corresponding to a selected account attribute option (processing block 940); and enabling the user to attribute or assign the account list of targeted accounts to a particular individual, entity, or activity (processing block 950).

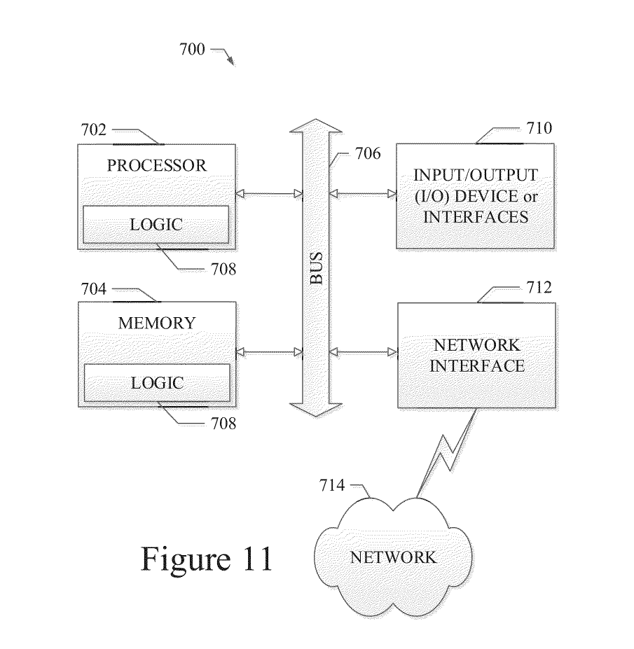

FIG. 11 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

We claim:

1. A system comprising:
a data processor;
a network interface, in data communication with the data processor, for communication on a data network; and
a predictive account management system, executable by the data processor, to:
provide data communication with a database including a plurality of accounts, each account having a plurality of associated account attributes;
generate a user interface for a user at a user platform;
present to the user, by use of the user interface, a plurality of account attribute options associated with the plurality of accounts;
enable the user to create an account list associated with a targeted portion of the plurality of accounts having account attributes corresponding to a selected account attribute option; and
enable the user to attribute or assign the account list of targeted accounts to a particular individual, entity, or activity.

2. The system as claimed in claim 1 being further configured to enable the user to specify a quantity of targeted accounts to include in the account list.

3. The system as claimed in claim 1 being further configured to include a specified number of highest ranking targeted accounts in the account list.

4. The system as claimed in claim 1 being further configured to enable the user to enter a name of the account list.

5. The system as claimed in claim 1 wherein the associated account attributes are of a type from the group consisting of: geographical attributes, topical attributes, business attributes, personnel attributes, temporal attributes, financial attributes, and online activity attributes.

6. The system as claimed in claim 1 wherein the plurality of account attribute options are from the group consisting of: geographical, topical, business, personnel, temporal, financial, and online activity.

7. The system as claimed in claim 1 wherein the predictive account management system is executable by the data processor on a user platform of a type from the group consisting of: a desktop computer, a mobile computing device, and a mobile phone.

8. A method comprising:
providing, by a data processor, data communication with a database including a plurality of accounts, each account having a plurality of associated account attributes;
generating, by the data processor, a user interface for a user at a user platform;
presenting to the user, by use of the user interface, a plurality of account attribute options associated with the plurality of accounts;
enabling the user to create an account list associated with a targeted portion of the plurality of accounts having account attributes corresponding to a selected account attribute option; and
enabling the user to attribute or assign the account list of targeted accounts to a particular individual, entity, or activity.

9. The method as claimed in claim 8 including enabling the user to specify a quantity of targeted accounts to include in the account list.

10. The method as claimed in claim 8 including collecting a specified number of highest ranking targeted accounts in the account list.

11. The method as claimed in claim 8 including enabling the user to enter a name of the account list.

12. The method as claimed in claim 8 wherein the associated account attributes are of a type from the group consisting of: geographical attributes, topical attributes, business attributes, personnel attributes, temporal attributes, financial attributes, and online activity attributes.

13. The method as claimed in claim 8 wherein the plurality of account attribute options are from the group consisting of: geographical, topical, business, personnel, temporal, financial, and online activity.

14. The method as claimed in claim 8 wherein the predictive account management system is executable by the data processor on a user platform of a type from the group consisting of: a desktop computer, a mobile computing device, and a mobile phone.

15. A non-transitory machine-useable storage medium embodying instructions which, when executed by a machine, cause the machine to:
provide data communication with a database including a plurality of accounts, each account having a plurality of associated account attributes;
generate a user interface for a user at a user platform;
present to the user, by use of the user interface, a plurality of account attribute options associated with the plurality of accounts;
enable the user to create an account list associated with a targeted portion of the plurality of accounts having account attributes corresponding to a selected account attribute option; and
enable the user to attribute or assign the account list of targeted accounts to a particular individual, entity, or activity.

16. The machine-useable storage medium as claimed in claim 15 being further configured to enable the user to specify a quantity of targeted accounts to include in the account list.

17. The machine-useable storage medium as claimed in claim 15 being further configured to include a specified number of highest ranking targeted accounts in the account list.

18. The machine-useable storage medium as claimed in claim 15 wherein the associated account attributes are of a type from the group consisting of: geographical attributes, topical attributes, business attributes, personnel attributes, temporal attributes, financial attributes, and online activity attributes.

19. The machine-useable storage medium as claimed in claim 15 wherein the plurality of account attribute options are from the group consisting of: geographical, topical, business, personnel, temporal, financial, and online activity.

20. The machine-useable storage medium as claimed in claim 15 wherein the predictive account management system is executable by the data processor on a user platform of a type from the group consisting of: a desktop computer, a mobile computing device, and a mobile phone.
